(19) United States
(12) Patent Application Publication
(10) Pub. No.: US 2024/0173838 A1
(43) Pub. Date: May 30, 2024

(54) SHIELD ARRANGEMENT AND BREAKING HAMMER

(71) Applicant: SANDVIK MINING AND CONSTRUCTION OY, Tampere (FI)

(72) Inventors: Erik AIRAS, Lahti (FI); Juho HUOTARI, Lahti (FI); Ilkka NIEMI, Lahti (FI); Juha INTONEN, Lahti (FI); Jarkko LUOKKALA, Lahti (FI)

(21) Appl. No.: 18/284,575

(22) PCT Filed: Mar. 29, 2022
(86) PCT No.: PCT/EP2022/058238

§ 371 Date: Sep. 28, 2023

(30) Foreign Application Priority Data
Mar. 30, 2021 (EP) 21165858.8

(51) Int. Cl. B25D 17/00; E02F 3/96

(52) U.S. Cl. CPC B25D 17/00; B25D 2250/121; E02F 3/966

(57) ABSTRACT

A shield arrangement, breaking hammer and method of protecting body of a breaking hammer is provided. The shield arrangement includes a shield element, which is mounted to the body by means of a separate sleeve-like element passing through an opening of the shield element. The sleeve-like element is a tool bushing, which also provides support for a breaking tool.

### RELATED APPLICATION DATA

This application is a § 371 National Stage Application of PCT International Application No. PCT/EP2022/058238 filed Mar. 29, 2022 with priority to EP 21165858.8 filed Mar. 30, 2021.

### BACKGROUND OF THE INVENTION

The invention relates to a shield arrangement for protecting a breaking hammer against mechanical wearing and deformation.

The invention further relates to a breaking hammer and to a method for providing a breaking hammer with mechanical protection.

Breaking hammers are used to break hard materials, such as rock, concrete, and the like. The breaking hammer comprises a percussion device for generating impact pulses to a breaking tool connectable to the breaking hammer. The breaking hammers are used in demanding conditions and their structure is subjected to different damaging phenomena. Therefore, the breaking hammer may be provided with a shield element which may cover a body of the breaking hammer and may thereby provide protection against dents and wearing. However, the known solutions have shown including drawbacks relating their complicated structure and mounting.

### BRIEF DESCRIPTION OF THE INVENTION

An object of the invention is to provide a novel and improved shield arrangement and breaking hammer, and further to provide a novel and improved method of providing a breaking hammer with mechanical protection.

An idea of the disclosed solution is that a breaking hammer is provided with a shield arrangement. The shield arrangement comprises one or more shield elements for providing mechanical protection for a body of the breaking hammer. The arrangement further comprises a separate sleeve-like element configured to serve as a fastening element for mounting the shield element to the body. Then the shield element comprises a through opening for receiving the sleeve-like element.

An advantage of the disclosed solution is that the structure of the shield arrangement and its mounting may be relatively simple.

According to an embodiment, the shield element is a removable and changeable wear part. Then the shield element can be easily replaced or repaired.

According to an embodiment, the shield element is configured to provide the mechanical protection only for a tool side end part of the body of the percussion hammer. In other words, the shield element is a low shield providing protection only for a lower end part of the body which may be subjected to intensive wearing during the rock breaking operation. An advantage is that the shield element does not increase weight of the breaking hammer unnecessarily and does not form visual obstruction.

According to an embodiment, fastening of the shield element is based on shape locking principle and the shield element is without any fastening screws, fastening screw holes, pins or corresponding elements intended for the fastening. An advantage is that the structure may be more tolerant against external forces and wearing when the structure is free of vulnerable fastening elements. Also dismounting and mounting at a work site may be facilitated.

According to an embodiment, the disclosed arrangement implements tool-free mounting principle. Thereby the shield arrangement can be replaced easily and quickly at a work site.

According to an embodiment, the sleeve-like element of the shield arrangement is a tool bushing comprising an inner opening for a breaking tool. In other words, the tool bushing is a dual purpose element serving as the fastening element for the shielding element, and it also serves as a support element for supporting and bearing the breaking tool. The shield element is supported on the outer surface of the tool bushing and the breaking tool is supported on the inner surface of the tool bushing.

According to an embodiment, the tool bushing is provided with slide bearing surfaces on its inner surfaces.

According to an embodiment, the tool bushing is provided with a thickened outer diameter at its one end which is surrounded by the shield element. Further, at the thickened end portion there is at least one sealing ring mounted on its inner periphery.

According to an embodiment, the tool bushing comprises at least one transverse locking opening for receiving a transverse locking pin. The locking pin is configured to fasten the shield element to the body of the percussion hammer via the tool bushing.

According to an embodiment, the shield element is fastened to the body only by means of the transverse locking pin.

According to an embodiment, between the shield element and the sleeve-like fastening element there are axial mating surfaces.

According to an embodiment, the axial mating surfaces are slanted i.e. they are angled relative to longitudinal axis of the sleeve-like fastening element. An advantage of the slanted mating surfaces is that they can center the shield element properly at the lower end part of the breaking hammer.

According to an embodiment, the axial mating surfaces are perpendicular relative to the longitudinal axis of the sleeve-like fastening element.

According to an embodiment, the shield element has a disc-shaped configuration.

According to an embodiment, the disc-shaped shield element comprises two components connected to each other removably in axial direction. Further, the components comprise inner flanges which together form an inner groove on an inner surface of the through hole of the shield element. The sleeve-like element comprises an outer flange on its outer surface and the outer flange is mounted to the groove defined by the inner flanges. Thus, there is a shape locking between the shield element and the sleeve-like fastening element.

According to an embodiment, the two-part shield element comprises a basic shield component and a locking ring component mounted axially to the basic shield component.

According to an embodiment, the disk-like shield element is formed of casted steel material.

According to an embodiment, the shield element comprises a bottom plate provided with the through opening. The shield element further comprises two or more side panels orientated transversally to the bottom plate. The shield element has an open top opposite to the bottom plate. In other words, the shield element provides limited protection only for the lower end part of the breaking hammer and at selected directions.

According to an embodiment, the shield element is formed of one or more sheet-like plates. The shield element may comprise one sheet plate being bent to desired shape, or alternatively there may be two or more plate pieces welded to each other.

According to an embodiment, the shield element is made of wear-resistant steel.

According to an embodiment, the shield element is made of rubber material or comprises at least one shield component or panel made of rubber material. As an alternative to the rubber, polyurethane (PU) or other plastic materials or composite materials can be implemented in the structure of the shield element.

According to an embodiment, the solution relates to a breaking hammer, which is provided with a shield arrangement which is in accordance with features disclosed in this document. The shield element is fastened to a body of the breaking hammer by means of a tool bushing intended for supporting a breaking tool to a first end of the body. In other words, the tool bushing not only supports the breaking tool but also serves as a simple and reliable fastening element for the shield element. This way, number of components may be decreased, and the structure is simple, durable, service free and inexpensive to manufacture.

According to an embodiment, the shield element is fastened to the body of the percussion hammer only by means of the tool bushing.

According to an embodiment, there may be damping material or damping elements arranged between inner surfaces of side panels of the shield element and outer surface of the body in order to dampen possible vibrations and noise. However, the damping material of elements do not provide fastening forces.

According to an embodiment, the fastening of the shield element is without any elements generating tightening forces between the shield element and the body. This way the fastening is simple and requires no tightening elements.

According to an embodiment, the body and the shield element are without any screw holes and screws. This is advantageous for durability of the shield and the body because the screw holes may weaken the structures.

According to an embodiment, the shield element is arranged between a distal axial end of the body and a flange which is located at a distal end portion of the tool bushing.

According to an embodiment, the tool bushing is mounted to the body by means of one or more transverse locking pins. Then the locking pin is configured to fasten the shield element to the body via the mentioned fastening of the tool bushing.

According to an embodiment, the shield element comprises an axial mating surface transverse to the mentioned opening. Then the axial mating surface can be supported against an axial distal surface of the body of the percussion hammer. Furthermore, the mentioned axial mating surface is the only contact surface configured to be in contact with the body of the percussion hammer.

According to an embodiment, the solution relates to a method of providing a breaking hammer with mechanical protection. The method comprises mounting a shielding element to cover a body of the breaking hammer at least partly. The method further comprises fastening the shielding element to the body by means of a tool bushing which also provides support for a breaking tool.

According to an embodiment, the disclosed method comprises allowing physical contact between the shield element and the body of the breaking hammer only for axial surfaces at a distal end of the body.

Let it be mentioned that the disclosed control principles and means are also suitable for other types of breaking hammers than those disclosed in this patent application.

The above-disclosed embodiments can be combined to form desired solutions provided with necessary features disclosed.

### BRIEF DESCRIPTION OF THE FIGURES

Some embodiments are described in more detail in the accompanying drawings, in which

FIG. 1 is a schematic side view of an excavator, which is provided with a breaking hammer;

FIG. 2 is a schematic view of a breaking hammer without any shielding element;

FIGS. 3-5 are schematic and exploded views of breaking hammers provided with different types of shielding arrangements at their tool side ends;

FIG. 6 is a schematic diagram showing some features relating to a shielding arrangement;

FIG. 7 is a schematic and cross sectional view of a tool side end of a breaking hammer and its tool bushing and shielding element;

FIG. 8 is a schematic and cross sectional view of a tool bushing and locking pins for fastening it; and

FIGS. 9-11 are schematic and cross sectional views of shielding arrangements mounted to tool side ends of breaking hammers.

For the sake of clarity, the Figures show some embodiments of the disclosed solution in a simplified manner. In the Figures, like reference numerals identify like elements.

### Detailed Description of Some Embodiments

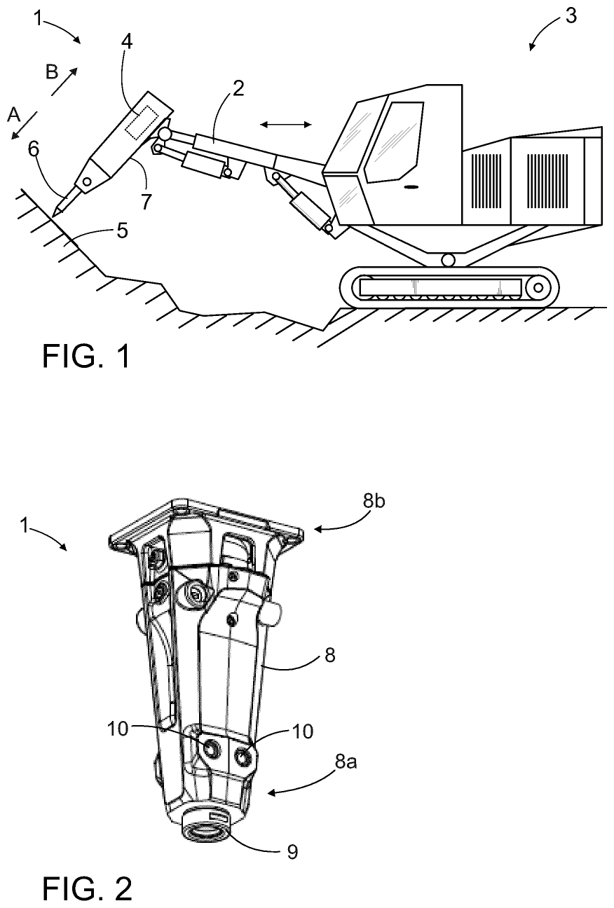

FIG. 1 shows a breaking hammer 1 arranged on a free end of a boom 2 in a working machine 3, such as an excavator. Alternatively, the boom 2 may be arranged on any movable carriage or on a fixed platform of a crushing apparatus. The breaking hammer 1 comprises a percussion device 4 for generating impact pulses. The breaking hammer 1 may be pressed by means of the boom 2 against material 5 to be broken and impacts may be simultaneously generated with the percussion device 4 to a tool 6 connected to the breaking hammer 1. The tool 6 transmits the impact pulses to the material 5 to be broken. The percussion device 4 may be hydraulic, whereby it may be connected to the hydraulic system of the working machine 2. The impact pulses are generated in the percussion device 4 by means of a percussion element, such as percussion piston, that may be moved back and forth in the impact direction and return direction under the influence of hydraulic fluid. Further, the breaking hammer 1 may comprise a shielding arrangement 7, inside which the breaking hammer 1 may be partly located.

FIG. 2 discloses a breaking hammer 1 comprising an elongated body 8 with a tool side end 8a and an opposite fastening side end 8b. At the tool side end 8a there is a tool bushing 9 through which a breaking tool can be mounted. The tool side end portion 8a further comprises transverse locking pins 10 for fastening the breaking tool axially movably in relation to the body 8.

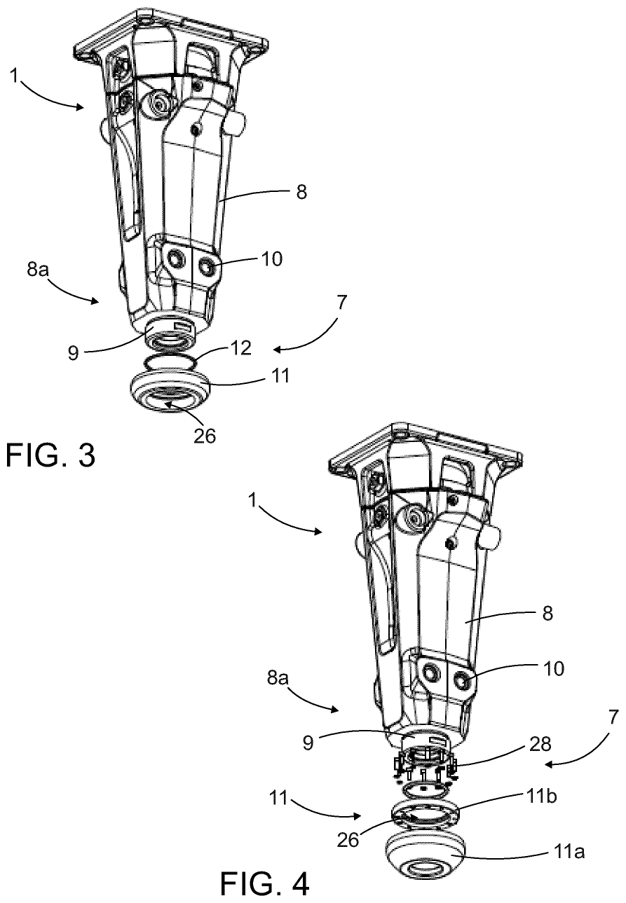

FIGS. 3-5 disclose some shielding arrangements 7. The shielding arrangements 7 comprise shielding elements 11 and separate sleeve-like fastening elements. In the disclosed solutions the tool bushings 9 serve as the mentioned separate sleeve-like elements. It can be noted that in FIGS. 3-5 the tool bushings 9 are mounted in place for clarity reasons and only the shielding elements 11 are shown apart from the body 8.

In FIG. 3 the shielding element 11 is a disc shaped element, which may be made of cast metal material, for example. There may be one or more sealing elements 12 between the shielding element 11 and the tool bushing 9.

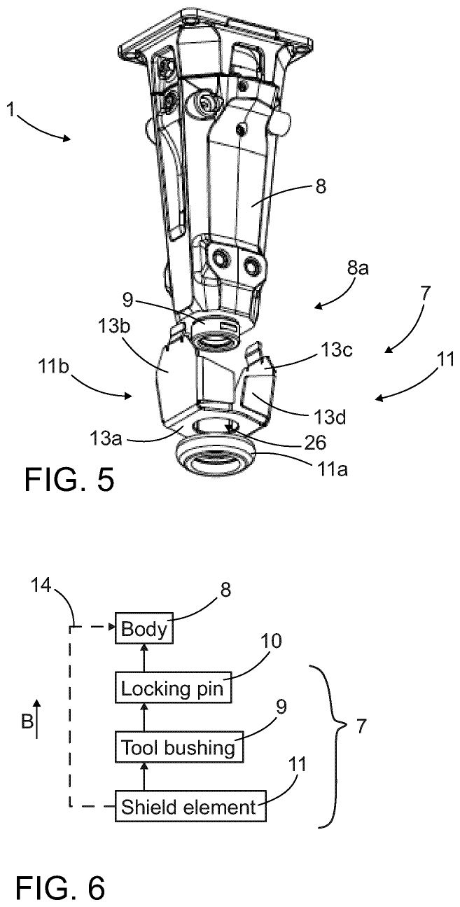

In FIG. 4 there is also a disc-shaped shield element 11. However, in this case the shield element 11 comprises two components 11a, 11b connected to each other removably in axial direction. The components 11a, 11b may be connected to each other by means of screws 28, for example. In FIG. 5 the shield element 11 comprises two components 11a and 11b, wherein a first component 11a is a ring-shaped or disc-shaped piece and a second component 11b is a casing type piece comprising a bottom plate 13a and side plates 13b-13d.

FIG. 6 illustrates a so called fastening chain wherein: a shield element 11 is fastened by means of a tool bushing 9; the tool bushing 9 is fastened by means of a locking pin 10; and the locking pin 10 is fastened to a body 8. An arrow 14 shows that the shield element 11 is supported to the body in a return direction B.

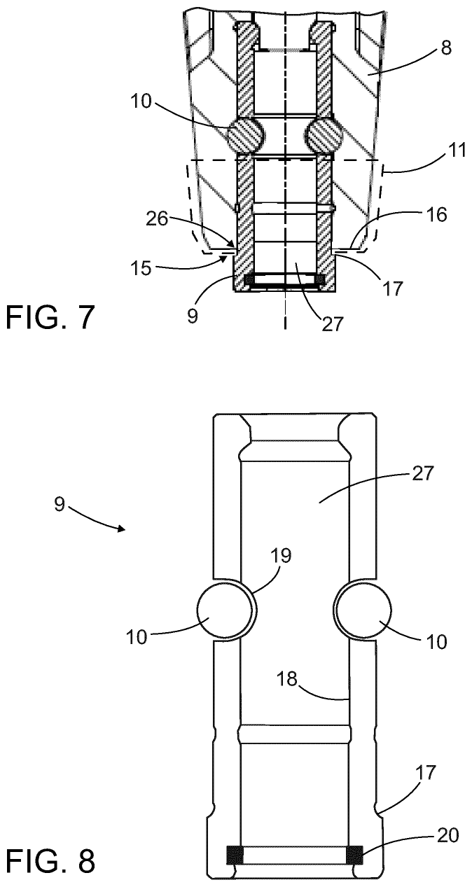

FIG. 7 discloses that there is a gap 15 between a front end surface 16 of a body 8 and a shoulder of flange 17 of a tool bushing 9. The gap 15 is used for mounting a shield element 11. The shield element 11 is shown in a simplified manner and using broken lines for improving thereby clarity. Shape of the shield element 11 may be a bell or a casing with open top, for example.

FIG. 8 discloses a tool bushing 9 which is an elongated sleeve-like piece. An inner surface 18 serves a slide bearing surface which is facing towards a breaking tool inserted inside to tool bushing 9. The tool bushing 9 and the breaking tool are both locked in place by means of one or two locking pins 10. The tool bushing 9 comprises one or two transverse locking openings 19 capable of receiving the locking pins 10. At a front end of the tool bushing 9 there is a shoulder 17, flange or corresponding enlarged portion which can be utilized when mounting a shielding element in accordance with the mounting principles disclosed in this document. The front end portion may also comprise a sealing element 20 for preventing impurities to enter inside the tool bushing 9 and for preventing grease to escape from the inside.

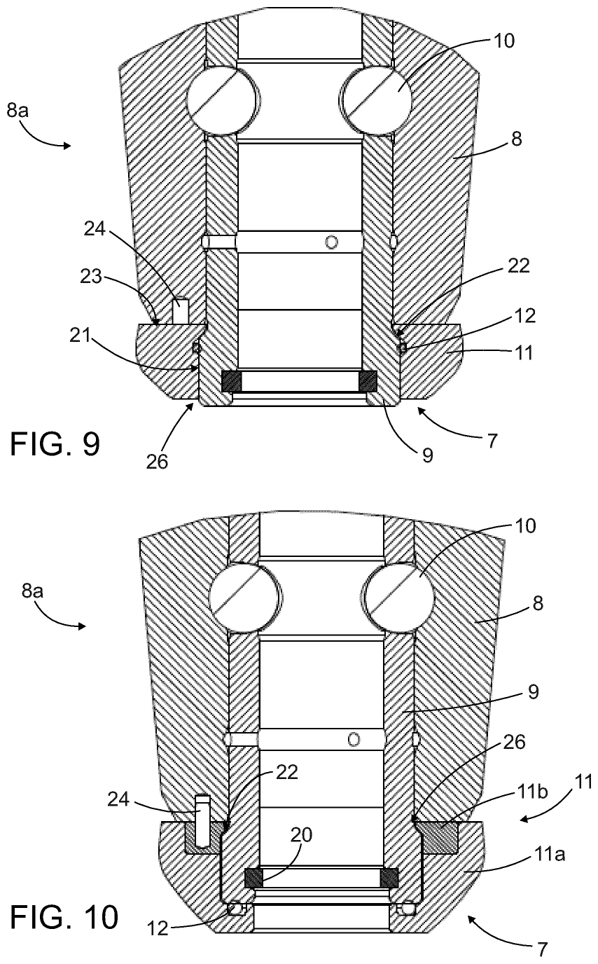

FIG. 9 discloses an embodiment, wherein a shield arrangement 7 comprises a disc-shaped shield element 11 and a tool bushing 9. Between the shield element 11 and the tool bushing 9 are radial mating surfaces 21 and axial mating surfaces 22. The axial mating surfaces 22 may be slanted. Between a body 8 and the shield element 11 are only axial mating surfaces 23.

FIG. 10 differs from the solution of FIG. 9 in that the shield element 11 comprises a first element 11a and a second element 11b, which are connected to each other removably. Due to the two-part structure the shield element 11 may also cover a front end surface of the tool bushing 9 and thereby provide axial protection for it. The solutions of FIGS. 9 and 10 have also somewhat different mounting principle since in the solution of FIG. 10 the shield element 11 is at first mounted to the tool bushing 9 and only thereafter the preassembled shield arrangement 7 pushed axially in place and is locked by means of the locking pins 10. In the solution of FIG. 9 the shield element 11 is placed against a front end surface of the body and thereafter the tool bushing 9 is pushed through an opening of the shield element in place, and finally the formed shield arrangement 7 is locked by means of locking pins 10.

The first element 11a may be a basic shield component for receiving the mechanical stresses and wearing, and the second shield element 11b may be a locking ring component mounted axially to the basic shield component.

FIGS. 9 and 10 further disclose that there may be guide pins 24 and sealing elements 12 in connection with the shielding arrangement 7.

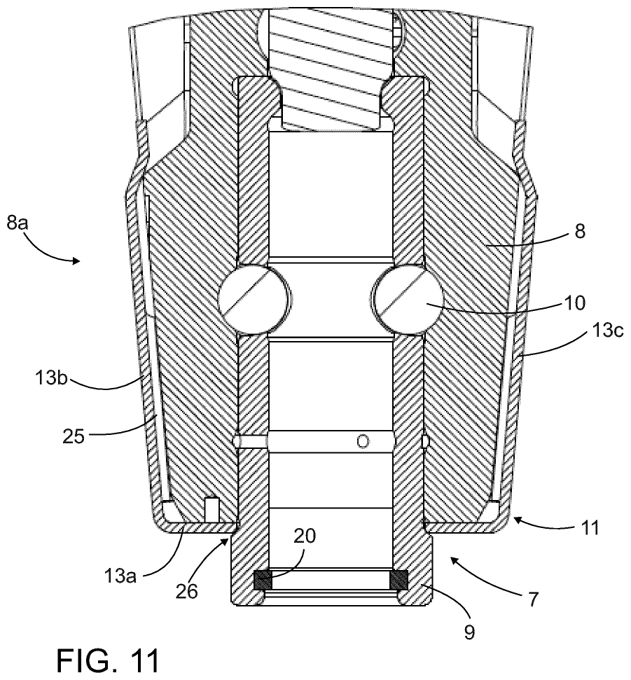

FIG. 11 discloses a solution which differs from the ones shown in FIGS. 9 and 10 in that the shield element 11 comprises a bottom plate 13a an one or several side plates 13b, 13c or panels. Shapes and dimensions of the side plates 13b, 13c can be selected case by case, of course.

Between the side plates 13a, 13b and an outer surface of the body 8 may be dampening elements 25 or material for preventing possible vibrations and noise. The dampening elements 25 may be separate elements or they may alternatively be inner surface layers or coatings.

In FIGS. 3-5, 7 and 9-11 it is further shown a through opening 26 for receiving the sleeve-like element, such as the tool bushing 9. FIGS. 7 and 8 disclose an inner opening 27 of a tool bushing 9 for receiving a breaking tool.

The drawings and the related description are only intended to illustrate the idea of the invention. In its details, the invention may vary within the scope of the claims.

1. A shield arrangement of a breaking hammer, the shield arrangement comprising:
at least one shield element arranged for providing mechanical protection for a body of the breaking hammer:
at least one fastening element arranged for mounting the shield element to the body; and
a separate sleeve-like element configured to as the fastening element, wherein the sleeve-like element is a tool bushing having an inner opening arranged to receive a breaking tool: wherein the shield element includes a through opening arranged for receiving the sleeve-like element, wherein the tool bushing has a thickened outer diameter at one end, which is surrounded by the shield element, and wherein the shield element is made of a wear-resistant steel, the tool bushing including at least one transverse locking opening arranged for receiving a transverse locking pin, whereby the locking pin is configured to fasten the shield element to the body of the breaking hammer via the tool bushing; and, and at the thickened end portion of the tool bushing there is at least one sealing ring mounted on its inner periphery.

2. The shield arrangement as claimed in claim 1, wherein between the shield element and the sleeve-like element there are axial mating surfaces.

3. The shield arrangement as claimed in claim 1, wherein the shield element has a disc-shaped configuration.

4. The shield arrangement as claimed in claim 1, wherein the shield element includes a bottom plate provided with the through opening, at least two side panels orientated transversally to the bottom plate, and an open top opposite to the bottom plate.

5. (canceled)

6. A breaking hammer, comprising:
an elongated body;
an impact device arranged inside the body and configured to generate impact pulses:
a tool bushing arranged for supporting a breaking tool to a first end of the body; and
a shield element arranged for providing mechanical protection for the body;
a shield arrangement in accordance with claim 1, wherein the shield element is fastened to the body by the tool bushing.

7. The breaking hammer as claimed in claim 6, wherein the shield element is fastened to the body only by the tool bushing.

8. The breaking hammer as claimed in claim 7, wherein the fastening of the shield element is without any elements generating tightening forces between the shield element and the body.

9. The breaking hammer as claimed in claim 6, wherein the shield element is arranged between a distal axial end of the body and a flange, which is located at a distal end portion of the tool bushing.

10. The breaking hammer as claimed in claim 6, wherein the tool bushing is mounted to the body by at least one transverse locking pin, the at least one locking pin being configured to fasten the shield element to the body via the fastening of the tool bushing.

11. The breaking hammer as claimed in claim 6, wherein the shield element includes an axial mating surface transverse to the through opening, whereby the axial mating surface is configured to be supported against an axial distal surface of the body of the breaking hammer, and wherein the axial mating surface is the only contact surface configured to be in contact with the body of the breaking hammer.
